(19) United States
(12) Patent Application Publication
(10) Pub. No.: US 2003/0193434 A1
(43) Pub. Date: Oct. 16, 2003

(54) GPS signal receiving and rebroadcasting device

(76) Inventors: Jeffrey J. Daggett, Thousand Oaks, CA (US); Joseph R.O. Amado, Camarillo, CA (US)

Correspondence Address: BABCOCK IP LLC, 24154 LAKESIDE DRIVE, LAKE ZURICH, IL, 60047, US

(21) Appl. No.: 10/122,562

(22) Filed: Apr. 15, 2002

(51) Int. Cl. G01S 1/08; G01S 5/14

(52) U.S. Cl. 342/386; 342/357.09

(57) ABSTRACT

A global positioning system (GPS) signal receiving and rebroadcasting device includes a first GPS antenna receiving GPS signals from a number of earth orbiting satellites, and a connector electrically connected to the first GPS antenna and configured for electrical connection to a voltage source. The connector supplies the voltage produced by the voltage source to the first GPS antenna via an electrical cable connected therebetween. The device further includes a second GPS antenna mounted within the connector and electrically connected to the first GPS antenna via a signal wire carried by the electrical cable. The first GPS antenna is operable to supply the received GPS signals to the second GPS antenna which, in turn, is operable to rebroadcast the GPS signals. The device is useful in enclosed environments requiring GPS access, wherein the first GPS antenna may be positioned to receive GPS signals.

### FIELD OF THE INVENTION

The present invention relates generally to global positioning system (GPS) signal receiving devices, and more specifically to such devices operable to rebroadcast received GPS signals.

### BACKGROUND AND SUMMARY OF THE INVENTION

Mobile electrical devices such as cellular telephones, notebook computers, personal digital assistants (PDAs), and the like may include global position system (GPS) equipment operable to receive and process GPS information, wherein such GPS equipment generally includes at least a GPS antenna and GPS decoding circuitry. However, in order to receive GPS signals from earth orbiting GPS satellites, the GPS antenna must have a clear view of the sky. This is not always possible with mobile devices, such as when such mobile devices are located within an enclosed environment such as a motor vehicle, home, business, airport, etc.

What is therefore needed is a GPS receiving and rebroadcasting device having a GPS antenna that may be positioned within a clear view of the sky, and which is operable to rebroadcast the received GPS signals within the enclosed environment. The present invention provides such a GPS receiving and rebroadcasting device.

These and other objects of the present invention will become more apparent from the following description of the preferred embodiments.

### BRIEF DESCRIPTION OF THE DRAWINGS

FIG. 1 is a diagrammatic illustration of one preferred embodiment of a GPS signal receiving and rebroadcasting device, in accordance with the present invention.

FIG. 2A is a diagrammatic illustration of one preferred embodiment of the voltage source-connecting end of the device of FIG. 1, configured for connection to a vehicle lighter socket, in accordance with the present invention.

FIG. 2B is a diagrammatic illustration of an alternate embodiment of the voltage source-connecting end of the device of FIG. 1, configured for connection to a conventional AC voltage panel through an AC-DC converter, in accordance with the present invention.

FIG. 2C is a diagrammatic illustration of another alternate embodiment of the voltage source-connecting end of the device of FIG. 1, configured for connection to a lighter socket that is itself configured for connection to a standard AC voltage panel through an AC-DC converter, in accordance with the present invention.

FIG. 3 is a circuit diagram illustrating one preferred embodiment of the electrical connections of the device of FIG. 1, in accordance with the present invention.

FIG. 4 is a block diagram illustrating various applications of the GPS signal receiving and rebroadcasting device of the present invention.

### DESCRIPTION OF THE PREFERRED EMBODIMENTS

For the purposes of promoting an understanding of the principles of the invention, reference will now be made to a number of preferred embodiments illustrated in the drawings and specific language will be used to describe the same. It will nevertheless be understood that no limitation of the scope of the invention is thereby intended.

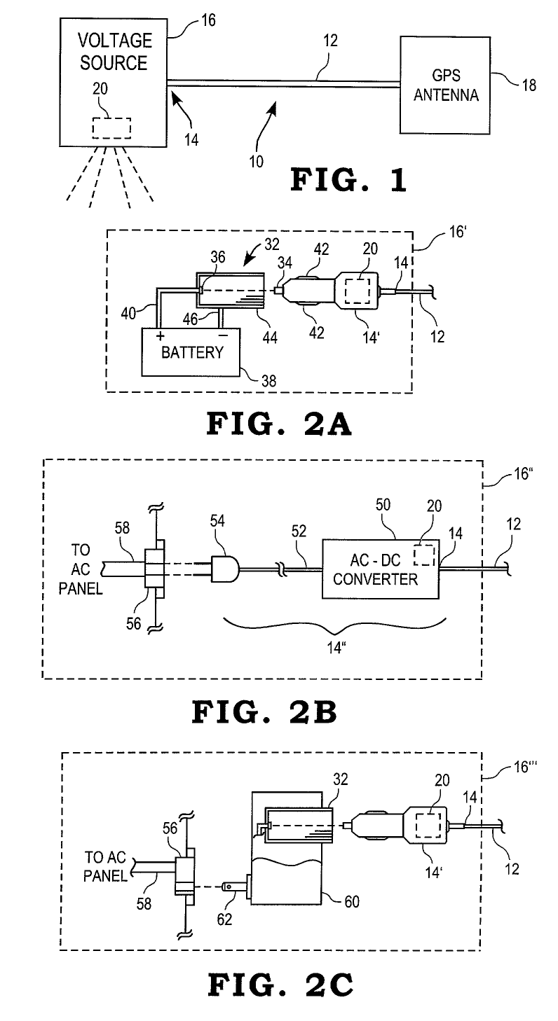

Referring now to FIG. 1, one preferred embodiment of a GPS signal receiving and rebroadcasting device 10, in accordance with the present invention, is shown. Device 10 includes an electrical cable 12 having a first end 14 configured for connection to a voltage source 16 and a second opposite end electrically connected to a GPS antenna 18 of known construction. The first end 14 of the electrical cable 12 may be configured for connection to any known DC voltage source, and some example configurations of connector end 14 and voltage source combinations are illustrated in FIGS. 2A-2C.

Referring to FIG. 2A, a first example voltage source arrangement 16′ is illustrated, wherein the first end 14 of cable 12 is connected to a terminal structure 14′ configured for electrical connection to a conventional cigarette lighter socket 32.

Terminal structure 14′ includes a first electrical terminal 34 electrically connected to a first electrical conductor of cable 12, and a second electrical terminal, defined by terminal elements 42, electrically connected to a second electrical conductor of cable 12. Complementarily configured lighter socket 32 includes a first electrical terminal 36 electrically connected to a positive terminal of a battery 38 via conductor 40, and a second electrical terminal, defined by the housing 44 of lighter socket 32, electrically connected to a negative terminal of the battery 38 via conductor 46. Terminal structure 14′ is configured to be engagingly received within lighter socket 32 such that the first electrical terminal 34 of structure 14′ electrically contacts the first electrical terminal 36 of socket 32 and the second terminal elements 42 electrically contact the socket housing 44, thereby supplying a DC voltage defined by battery 38 to the first and second conductors of cable 12. In one embodiment, the lighter socket 32 and battery 38 are carried by a motor vehicle, wherein the lighter socket 32 is typically located in the dash area or other convenient location of the vehicle. Alternatively, battery 38 and lighter socket 32 may be provided as a portable voltage source.

Referring to FIG. 2B, a second example voltage source arrangement 16″ is illustrated, wherein the first end 14 of cable 12 is connected to a terminal structure 14″ configured for electrical connection to an AC voltage source via a wall socket 56. Terminal structure 14″ includes an AC-to-DC converter of known construction having a DC output end electrically connected to the first end 14 of cable 12, and an AC input end electrically connected to a conventional two (or three) prong plug 54 via conductor cable 52, wherein plug 54 is configured for electrical engagement with a conventional wall socket 56. Wall socket 56 is connected to an AC voltage source (not shown) via wiring 58, wherein the AC voltage source may typically be a conventional 120 volt or 240 volt electrical panel. In any case, AC voltage supplied to wall socket 56 is provided by plug 54 to the AC input of the AC-to-DC converter 50, which is operable to convert the AC voltage to a suitable DC voltage (e.g., 5, 7, 9 or 12 volts, or any other voltage required by the particular application of the GPS signal receiving and rebroadcasting device 10), and to provide this DC voltage to the electrical conductors carried by cable 12.

Referring to FIG. 2C, a third example voltage source arrangement 16′″ is illustrated, wherein the first end 14 of cable 12 is connected to the terminal structure 14′ described hereinabove with respect to FIG. 2A. In this embodiment, a lighter socket 32 is electrically connected to a DC output of an AC-to-DC converter unit 60 of known construction having an AC input electrically connected to a conventional two (or three) prong plug 62, wherein plug 62 is configured for electrical engagement with a conventional wall socket 56. Wall socket 56 is connected to an AC voltage source (not shown) via wiring 58, as described hereinabove with respect to FIG. 2B, wherein the AC voltage source may typically be a conventional 120 volt or 240 volt electrical panel. In any case, AC voltage supplied to wall socket 56 is provided by plug 62 to the AC input of the AC-to-DC converter 60, which is operable to convert the AC voltage to a suitable DC voltage (e.g., 5, 7, 9 or 12, volts or any other voltage required by the particular application of the GPS signal receiving and rebroadcasting device 10), and to provide this DC voltage to lighter socket 32. The terminal structure 14′ may be received within lighter socket 32, as described hereinabove with respect to FIG. 2A, to supply the DC voltage provided by converter 60 to the electrical conductors carried by cable 12.

It is to be understood that the connector end 14 and voltage source configurations shown and described with respect to FIGS. 2A-2C are provided only by way of example. Those skilled in the art will recognize other voltage source configurations and techniques for supplying a suitable DC voltage to the first end 14 of the electrical cable 12 of the present invention, and such other voltage source configurations and techniques are intended to fall within the scope of the present invention.

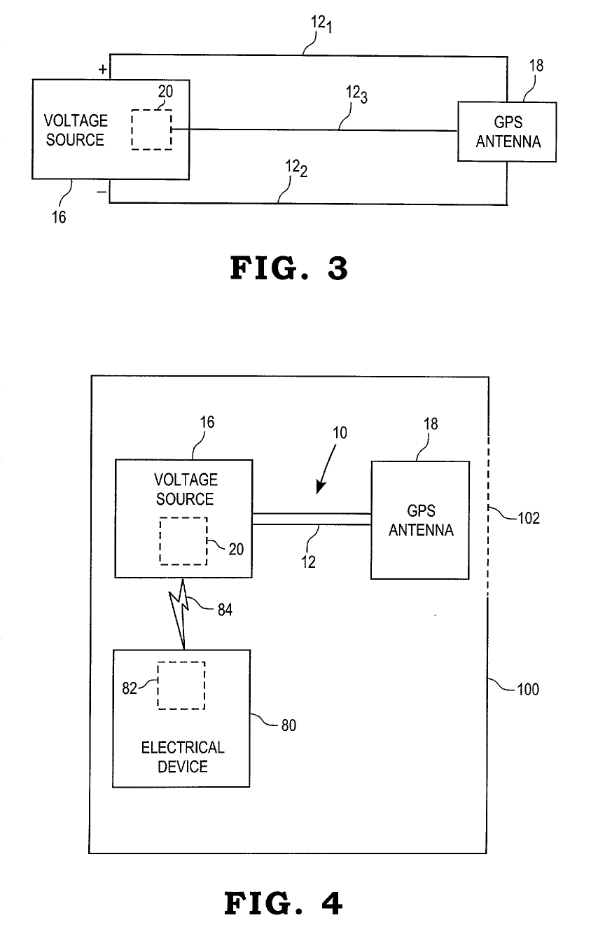

In accordance with the present invention, the connection structure of the first end 14 of the electrical cable 12 to the voltage source 16 includes a second GPS antenna 20, wherein antenna 20 is represented in FIG. 1 as being generally included within the voltage source 16. In the embodiments 16′ and 16′″ of the voltage source 16 illustrated in FIGS. 2A and 2C respectively, the second GPS antenna 20 is located within the terminal structure 14′. In the embodiment 16″ of the voltage source 16 illustrated in FIG. 2B, the second GPS antenna 20 is located within the AC-DC converter 50. Those skilled in the art will recognize that the GPS antenna 20 illustrated in each of the foregoing embodiments may be mounted within, or to, the respective terminal structure 14′ or AD-DC converter 50, or may alternatively be mounted to or within any adjacent structure, such as cable 12, conductor cable 52, plug 54, or AC-to-DC converter 60, and that any such location and mounting arrangement of the GPS antenna 20 is intended to fall within the scope of the present invention. In any case, GPS antenna 20 is electrically connected to GPS antenna 18 via one or more signal lines carried by electrical cable 12, as will be described in greater detail with respect to FIG. 3.

Referring now to FIG. 3, a circuit diagram illustrating one preferred embodiment of the electrical connections of the device of FIG. 1, in accordance with the present invention, is shown. In the embodiment shown, the electrical cable 12 includes two wires 12₁ and 12₂ carrying a DC voltage supplied by voltage source 16, and providing this DC voltage to the GPS antenna 18. Cable 12 further includes a third signal wire 12₃ connecting a signal output of GPS antenna 18 to a signal input of GPS antenna 20. GPS signals received by GPS antenna 18 are supplied by GPS antenna 18 to GPS antenna 20 via signal line 12₃. It is to be understood that the foregoing embodiment of the electrical connections of the device of FIG. 1 is provided only by way of example, and that the present invention contemplates alternative electrical connection embodiments. For example, the voltage source 16 and GPS Antenna 18 may, in some applications, be grounded to a common ground structure, in which case electrical cable 12 need only connect voltage source 16 to GPS antenna 18 via a single wire (e.g., 12₁). As another example, electrical cable 12 may, in some applications, include additional signal wires (e.g., in addition to wire 12₃) connecting GPS antenna 18 and GPS antenna 20. Any such or similar modifications to the electrical connection arrangement illustrated in FIG. 3 are intended to fall within the scope of the present invention.

Referring now to FIG. 4, a block diagram illustrating various applications of the GPS signal receiving and rebroadcasting device 10 of the present invention is shown. The GPS signal receiving and rebroadcasting device 10 is shown in FIG. 4 as being housed within an enclosed structure 100 including at least one opening or window 102. In one embodiment, structure 100 represents a motor vehicle and opening 102 represents a window of the motor vehicle, and may be a vehicle windshield, rear window or side window. GPS antenna 18, in this embodiment, may be mounted to, or adjacent to, window 102, and in any case should be positioned relative to window 102 to have a clear view of the sky. In this embodiment, the voltage source 16 may be, for example, embodiment 16′ illustrated in FIG. 2A. In an alternate embodiment, structure 100 represents a building, such as a residence, business or other building, and opening 102 represents a window, door or other opening defined by the building 100. GPS antenna 18, in this embodiment, may be mounted to, or adjacent to, opening 102, and in any case should be positioned relative to opening 102 to have a clear view of the sky. In this embodiment, the voltage source 16 may be, for example, either of the embodiments 16″ or 16′″ illustrated in FIGS. 2B and 2C, respectively.

The GPS antenna 18 is operable to receive GPS signals transmitted by a number of earth orbiting satellites, and to provide such signals to GPS antenna 20 via at least one signal wire (e.g., wire 12₃) carried by the electrical cable 12. The GPS antenna 20 is then operable to transmit, or rebroadcast, the GPS signals provided by GPS antenna 18. An electrical device 80 having a third GPS antenna 82 is then operable to receive the GPS signals rebroadcast by GPS antenna 20 via wireless link 84. Thus, in environments (e.g., within a motor vehicle, residence, business, restaurant, airport, etc.) wherein adequate reception of GPS signals is impractical or impossible, the GPS signal receiving and rebroadcasting device 10 of the present invention provides a mechanism for receiving GPS signals and transmitting such GPS signals to an electrical device positioned within the enclosed environment 100 and operable to process such GPS signals. Examples of electrical device 80 include, but are not limited to, cellular telephones, notebook computers, personal digital assistants (PDAs), hand-held GPS navigation devices, and the like.

While the invention has been illustrated and described in detail in the foregoing drawings and description, the same is to be considered as illustrative and not restrictive in character, it being understood that only preferred embodiments thereof have been shown and described and that all changes and modifications that come within the spirit of the invention are desired to be protected.

What is claimed is:

1. A global positioning system (GPS) signal receiving and rebroadcasting device, comprising:
a first GPS antenna configured to receive GPS signals transmitted by a number of earth orbiting GPS satellites; and
a connector configured for electrical connection to a voltage source and supplying voltage produced by the voltage source to said first GPS antenna, said connector including a second GPS antenna receiving from said first GPS antenna said GPS signals transmitted by a number of earth orbiting satellites, said second GPS antenna rebroadcasting said GPS signals received from said first GPS antenna.

2. The device of claim 1 further including an electrical cable having a first end electrically connected to said first GPS system and a second opposite end electrically connected to said connector, said electrical cable including at least one conductor supplying said voltage produced by the voltage source to said first GPS antenna.

3. The device of claim 2 wherein said electrical cable includes at least one signal line connecting said first GPS antenna to said second GPS antenna, said second GPS antenna receiving said GPS signals received from said first GPS antenna via said at least one signal line.

4. The device of claim 1 wherein said connector defines a terminal structure configured for connection to a lighter socket.

5. The device of claim 4 wherein said lighter socket is carried by a motor vehicle;
and wherein the voltage source is a vehicle battery electrically connected to said lighter socket.

6. The device of claim 4 further including an AC-to-DC converter having an AC input configured for electrical connection to an AC voltage source and a DC output electrically connected to said lighter socket;
and wherein the voltage source is said AC voltage source.

7. The device of claim 1 wherein said connector is electrically connected to a DC output of an AC-to-DC converter having an AC input configured for electrical connection to an AC voltage source
and wherein the voltage source is said AC voltage source.

8. A global positioning system (GPS) signal receiving and rebroadcasting device, comprising:
a first GPS antenna configured to receive GPS signals transmitted by a number of earth orbiting GPS satellites;
a signal line having a first end electrically connected to said first GPS antenna and a second end; and
a second GPS antenna electrically connected to said second end of said signal line, said second GPS antenna receiving from said first GPS antenna via said signal line said GPS signals transmitted by a number of earth orbiting satellites, said second GPS antenna rebroadcasting said GPS signals received from said first GPS antenna.

9. The device of claim 8 further including a connector configured for electrical connection to a voltage source and electrically connected to said first GPS via at least one electrical conductor, said connector supplying voltage produced by the voltage source to said first GPS antenna via said at least one electrical conductor.

10. The device of claim 9 further including an electrical cable connecting said connector to said first GPS antenna, said electrical cable carrying said signal line and said at least one electrical conductor.

11. The device of claim 10 wherein said connector includes said second GPS antenna.

12. The device of claim 9 wherein said connector defines a terminal structure configured for connection to a lighter socket.

13. The device of claim 12 wherein said lighter socket is carried by a motor vehicle;
and wherein the voltage source is a vehicle battery electrically connected to said lighter socket.

14. The device of claim 12 further including an AC-to-DC converter having an AC input configured for electrical connection to an AC voltage source and a DC output electrically connected to said lighter socket;
and wherein the voltage source is said AC voltage source.

15. The device of claim 19 wherein said connector is electrically connected to a DC output of an AC-to-DC converter having an AC input configured for electrical connection to an AC voltage source
and wherein the voltage source is said AC voltage source.

16. A global positioning system (GPS) signal receiving and rebroadcasting device, comprising:
a first GPS antenna configured to receive GPS signals transmitted by a number of earth orbiting GPS satellites;
an electrical cable having a first end electrically connected to said first GPS antenna and a second end; and
a connector electrically connected to said second end of said electrical cable and configured for electrical connection to a voltage source, said connector supplying voltage from the voltage source to said first GPS antenna via said electrical cable, said connector including a second GPS antenna receiving from said first GPS antenna via said electrical cable said GPS signals transmitted by a number of earth orbiting satellites, said second GPS antenna rebroadcasting said GPS signals received from said first GPS antenna.

17. The device of claim 16 wherein said connector defines a terminal structure configured for connection to a lighter socket.

18. The device of claim 17 wherein said lighter socket is carried by a motor vehicle;
and wherein the voltage source is a vehicle battery electrically connected to said lighter socket.

19. The device of claim 17 further including an AC-to-DC converter having an AC input configured for electrical connection to an AC voltage source and a DC output electrically connected to said lighter socket;
and wherein the voltage source is said AC voltage source.

20. The device of claim 16 wherein said connector is electrically connected to a DC output of an AC-to-DC converter having an AC input configured for electrical connection to an AC voltage source
and wherein the voltage source is said AC voltage source.
